(19) United States
(12) Patent Application Publication
(10) Pub. No.: US 2011/0285094 A1
(43) Pub. Date: Nov. 24, 2011

(54) Ring Seal With Offset Centroids

(75) Inventor: Vance W. Henry, Easton, PA (US)

(73) Assignee: Victaulic Company, Easton, PA (US)

(21) Appl. No.: 12/784,831

(22) Filed: May 21, 2010

(51) Int. Cl. F16J 15/10; F16L 13/14; F16J 15/06

(52) U.S. Cl. 277/626

(57) ABSTRACT

A seal used with crimp-type couplings to provide a fluid tight joint has a ring that surrounds a point. The ring has a multiplicity of cross sections. Each cross section may have the same shape and area at every position along the entire length of the ring. Each cross section has a centroid. The ring is divided into portions. Each portion subtends an angle measured about the point. Each portion is characterized by the distance from the point to the centroids of the cross sections within the portion. Centroids of the cross sections in a first portion are positioned at the same distance from the point. Centroids of the cross sections in another portion are positioned at respective points different from the distance associated with the first portion. By offsetting the centroids leak paths are intentionally created before the joint is crimped to prevent false indications of a crimped joint.

### FIELD OF THE INVENTION

This invention relates to seals used with crimp-type couplings.

### BACKGROUND

Crimp-type or press fit pipe couplings find widespread use due to their simplicity, ease of installation and reliability in forming fluid tight joints in piping networks. Crimp-type couplings typically have a socket with an inner diameter sized to coaxially receive the end of a pipe element. There is also an elastomeric seal, such as an O-ring, positioned between the inner surface of the coupling and the outer surface of the pipe element. The seal may be housed within an inwardly facing circumferential groove in the coupling.

In operation, the pipe element is inserted into the socket of the coupling and a crimping or pressing tool is used to apply an inward radial force to the outer surface of the coupling at or near the position of the seal. The applied force deforms the pipe coupling and the pipe element, and the mutual deformation forms a mechanical joint between the coupling and the pipe element. The elastomeric seal is compressed between, and conforms to, the inner surface of the coupling and the outer surface of the pipe element to provide fluid tightness.

Once the piping network is completed the system is tested for potential leaks by filling the network with compressed air or a liquid at pressures as high as one and a half times the service pressure. If pressure is maintained within the system then it is assumed that all the joints are fluid tight and the system is ready for use.

However, it is possible that, due to the dimensional tolerances on the coupling and the pipe element, as well as the O-ring seal, a crimp-type joint may hold the test pressure without being crimped, i.e., if the inner diameter of the coupling is at the small end of the allowable tolerance and the pipe element has an outer diameter at the large end of the allowable tolerance, and the thickness of the seal is also at the large end of its allowable tolerance, then the joint formed merely by inserting the pipe element into the socket of the coupling may compress the seal sufficiently between the coupling and the pipe element to attain fluid-tightness up to or beyond the test pressure. Furthermore, it is not always possible to visually determine if a pipe joint has been crimped. These elements can lead to a disaster, because, if visual inspection cannot be used or is carelessly performed, and pressure testing indicates a piping network is fluid tight even though all joints are not crimped, then application of service pressures to the piping network in the course of normal use may eventually lead to leaking or even the blow-out of non-crimped joints and potentially catastrophic flooding. It is clear that there is a need for a seal which avoids these potential problems.

### SUMMARY

The invention concerns a seal, for example, a seal used with crimp-type pipe couplings to ensure a fluid tight joint. In one embodiment, the seal comprises a ring surrounding a point. The ring has a multiplicity of cross sections. The cross sections are identical to one another in shape and area at every position along the entire length of the ring. In alternate embodiments, some of the cross sections may have identical shapes but different areas in comparison with other cross sections, or, some cross sections may have identical areas having different shapes from other cross sections. Each of the cross sections has a centroid. A first portion of the ring subtends a first angle measured about the point. The centroid of every cross section within the first portion is positioned at a first distance from the point. A second portion of the ring subtends a second angle measured about the point. The centroid of every cross section within the second portion is positioned at a distance from the point different from the first distance.

The seal may further comprise a plurality of the first portions and a plurality of the second portions. Each of the second portions is positioned between two of the first portions. In one embodiment, each one of the first angles may be greater than each one of the second angles. The seal may comprise at least four of the first portions and four of the second portions. Each of the second portions is positioned between two of the first portions.

Each of the first portions may subtend an angle from about 40° to about 70° depending upon the size of the seal. In particular, for a seal sized for ½ inch pipe the first portion may subtend an angle of about 45°; for a seal sized for ¾ inch pipe the first portion may subtend an angle of about 55°; for a seal sized for 1 inch pipe the first portion may subtend an angle of about 60°; for a seal sized for 1½ inch pipe the first portion may subtend an angle of about 60°; and for a seal sized for 2 inch pipe the first portion may subtend an angle of about 60°. Each of the second portions may subtend an angle from about 20° to about 50° depending upon the size of the seal. In particular, for a seal sized for ½ inch pipe the second portion may subtend an angle of about 45°; for a seal sized for ¾ inch pipe the second portion may subtend an angle of about 35°; for a seal sized for 1 inch pipe the second portion may subtend an angle of about 30°; for a seal sized for 1½ inch pipe the second portion may subtend an angle of about 30°; and for a seal sized for 2 inch pipe the second portion may subtend an angle of about 30°.

In one embodiment of the seal, the centroids located within the second portions are positioned at respective distances from the point less than the first distance. Alternately, the centroids located within the second portions may be positioned at respective distances from the point greater than the first distance. At least some of the centroids located within said second portion may lie on a circle having its center outside of the ring. The ring may be formed of an elastic material.

### BRIEF DESCRIPTION OF THE DRAWINGS

FIGS. 1, 1A and 1B are plan views of an embodiment of a seal according to the invention;

FIG. 2 is a cross sectional view taken at line 2-2 of FIG. 1;

FIG. 3 is a cross sectional view taken at line 3-3 of FIG. 1;

FIG. 4 is a plan view of another embodiment of a seal according to the invention;

FIG. 5 is a cross sectional view taken at line 5-5 of FIG. 4;

FIG. 6 is a cross sectional view taken at line 6-6 of FIG. 4;

FIG. 7 is a plan view of another embodiment of a seal according to the invention;

FIG. 8 is a cross sectional view taken at line 8-8 of FIG. 7;

FIG. 9 is a cross sectional view taken at line 9-9 of FIG. 7;

FIG. 10 is a plan view of another embodiment of a seal according to the invention;

FIG. 11 is a cross sectional view taken at line 11-11 of FIG. 10;

FIG. 12 is a cross sectional view taken at line 12-12 of FIG. 10;

FIG. 13 is a plan view of another embodiment of a seal according to the invention;

FIG. 14 is a cross sectional view taken at line 14-14 of FIG. 13;

FIG. 15 is a cross sectional view taken at line 15-15 of FIG. 13;

FIG. 16 is a longitudinal sectional view of a crimp-type coupling using a seal according to the invention;

FIG. 17 is a cross sectional view taken at line 17-17 of FIG. 16;

FIG. 18 is a longitudinal sectional view of the crimp-type coupling shown in FIG. 16 after being crimped to effect a joint; and

FIG. 19 is a cross sectional view of the crimped coupling taken at line 19-19 of FIG. 18.

### DETAILED DESCRIPTION

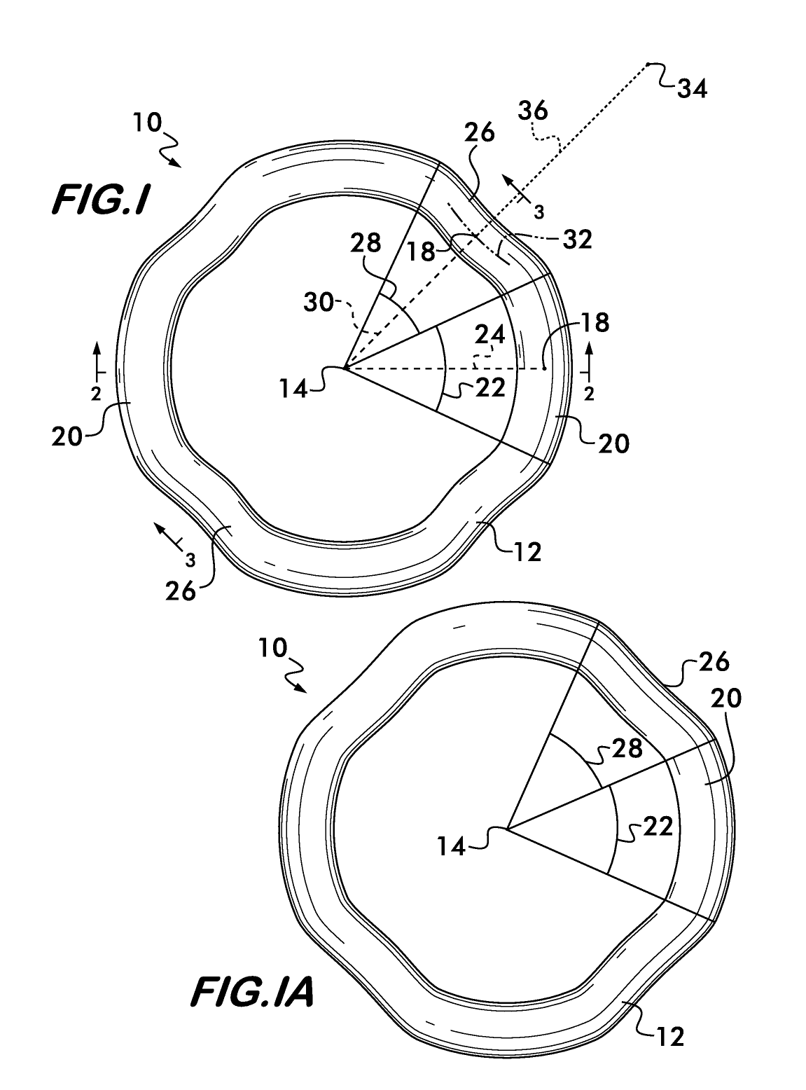

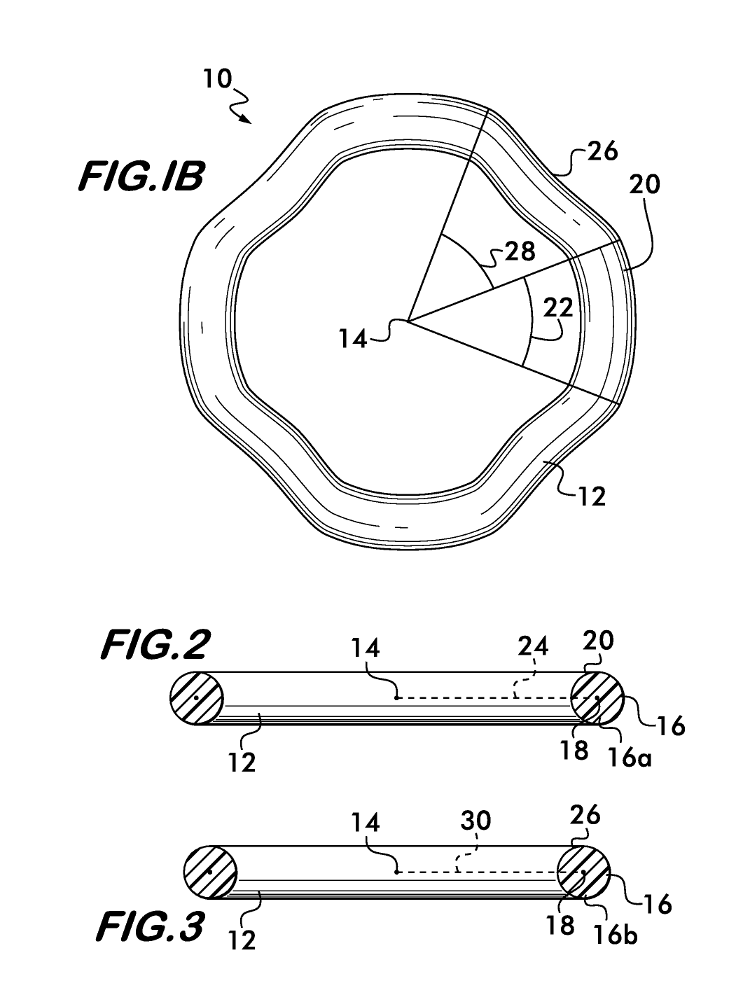

FIG. 1 depicts an embodiment of a seal 10 according to the invention. Seal 10 comprises a ring 12 which surrounds a point 14. The ring is formed of a multiplicity of cross sections 16, examples of which are shown in FIGS. 2 and 3. All of the cross sections 16 in this embodiment have the same shape and area. Each cross section has a centroid 18. The centroid is also known as the geometric center of the cross section and is defined as the point of intersection of all straight lines that divide the cross section into two parts of equal moment about each of the lines. In this example, the cross section 16 is circular and the centroid 18 is located at the center of the circle. Other cross sectional shapes are contemplated, as described below.

With reference again to FIG. 1, ring 12 is divided into portions characterized by the distance of the centroid of the cross sections in that portion from the point 14. In the example embodiment shown, a portion 20 of ring 12 subtends an angle 22 measured about the point 14. For all cross sections 16a considered part of portion 20, the distance 24 from point 14 to each centroid 18 is the same (see also FIG. 2). Ring 12 has another portion 26 which subtends an angle 28. For all of the cross sections 16b considered part of portion 26, the distance 30 from the point 14 to the centroid 18 is different from the distance 24 (see also FIG. 3). In this example embodiment, the distance 30 is less than the distance 24, giving the kinked appearance shown in FIG. 1, where the portion 26 is curved inwardly toward point 14 while the centroids 18 of portion 20 maintain a constant radius of curvature relative to point 14. In this example, most of the centroids 18 of the cross sections 16b of portion 26 lie on a circle 32, shown in phantom line, having its center 34 outside of the ring 12 at a radius 36. To avoid a sharp angle transition between the first and second portions 20 and 26, the centroids 18 in these transition regions lie on a curve which smoothly blends the two circular arcs formed by the portions 20 and 26. Alternately, the centroids 18 within portion 26 may lie on other curves or lines of other shapes, which would impart a different overall shape to seal 10.

As shown in FIG. 1, ring 12 comprises a plurality of portions, in this example eight, four portions 20 and four portions 26. The portions are arranged in alternating fashion, wherein each portion of one type is positioned between two portions of another type. Thus for example, any portion 26 is positioned between two portions 20, and any portion 20 is positioned between two portions 26. Further in the example shown, the angle 22 subtended by portions 20 is greater than the angle 28 subtended by portions 26, it being understood that the subtended angles 22 and 28 could be equal, as shown in FIG. 1A, or angle 22 could be less than angle 28, as shown in FIG. 1B.

In certain practical embodiments, the angle 22 subtended by portions 20 may be from about 40° to about 70° depending upon the size of the seal 10. For example, for a seal sized for ½ inch pipe, portion 20 may subtend an angle 22 of about 45°; for a seal sized for ¾ inch pipe, portion 20 may subtend an angle 22 of about 55°; for a seal sized for 1 inch pipe, portion 20 may subtend an angle 22 of about 60°; for a seal sized for 1½ inch pipe, portion 20 may subtend an angle 22 of about 60°; and for a seal sized for 2 inch pipe, portion 20 may subtend an angle 22 of about 60°.

Furthermore, in certain practical embodiments, the angle 28 subtended by portions 26 may be from about 20° to about 50° depending upon the size of the seal 10. For example, for a seal sized for ½ inch pipe, portion 26 may subtend an angle 28 of about 45°; for a seal sized for ¾ inch pipe, portion 26 may subtend an angle 28 of about 35°; for a seal sized for 1 inch pipe, portion 26 may subtend an angle 28 of about 30°; for a seal sized for 1½ inch pipe, portion 26 may subtend an angle 28 of about 30°; and for a seal sized for 2 inch pipe, portion 26 may subtend an angle 28 of about 30°.

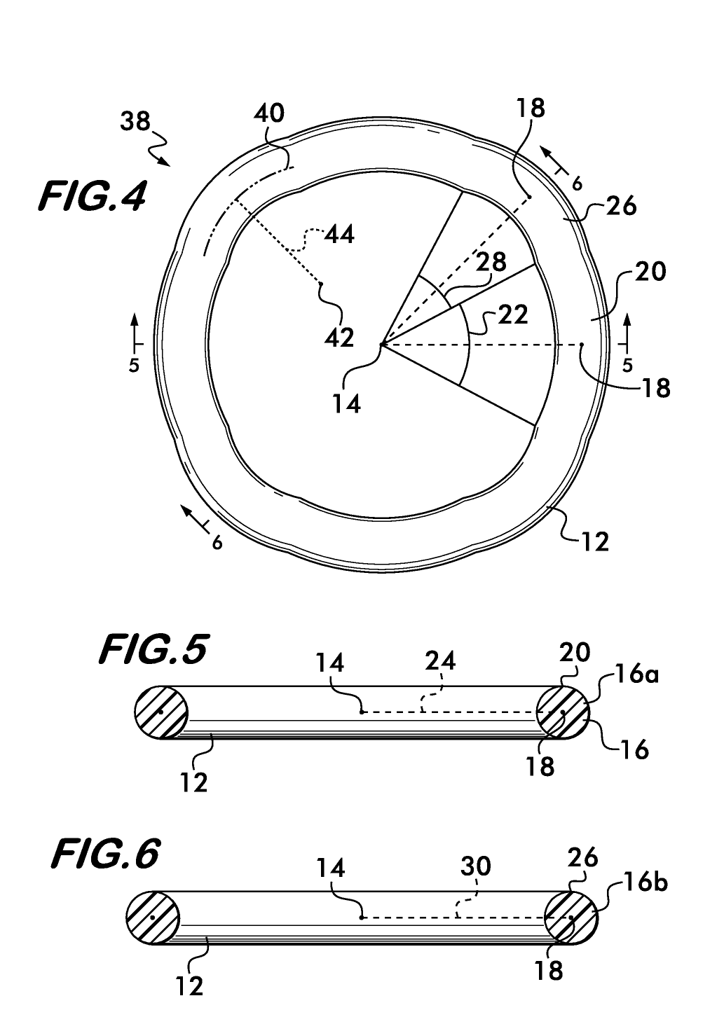

FIG. 4 shows another example embodiment of a seal 38 according to the invention. In this example, the ring 12 comprising the seal is again divided into a plurality of portions 20 and 26. Portions 20 subtend angles 22 and portions 26 subtend angles 28. The centroids 18 of cross sections 16a comprising portions 20 (see also FIG. 5) are all positioned at the same distance 24 from the point 14, and the centroids 18 of cross sections 16b of portions 26 are positioned at a different distance 30, distance 30 in this example being greater than distance 24 (see also FIG. 6). This imparts a different characteristic shape to seal 38 in comparison with seal 10 shown in FIG. 1 wherein the portions 26 curve outwardly away from the point 14. In the example seal 38 shown in FIG. 4, most of the centroids 18 of cross sections 16b of portions 26 lie on a circle 40, shown in phantom line, having its center 42 within the ring 12 at a radius 44. Alternately, the centroids 18 within portion 26 may lie on other curves or lines of other shapes, which would impart a different overall shape to seal 38.

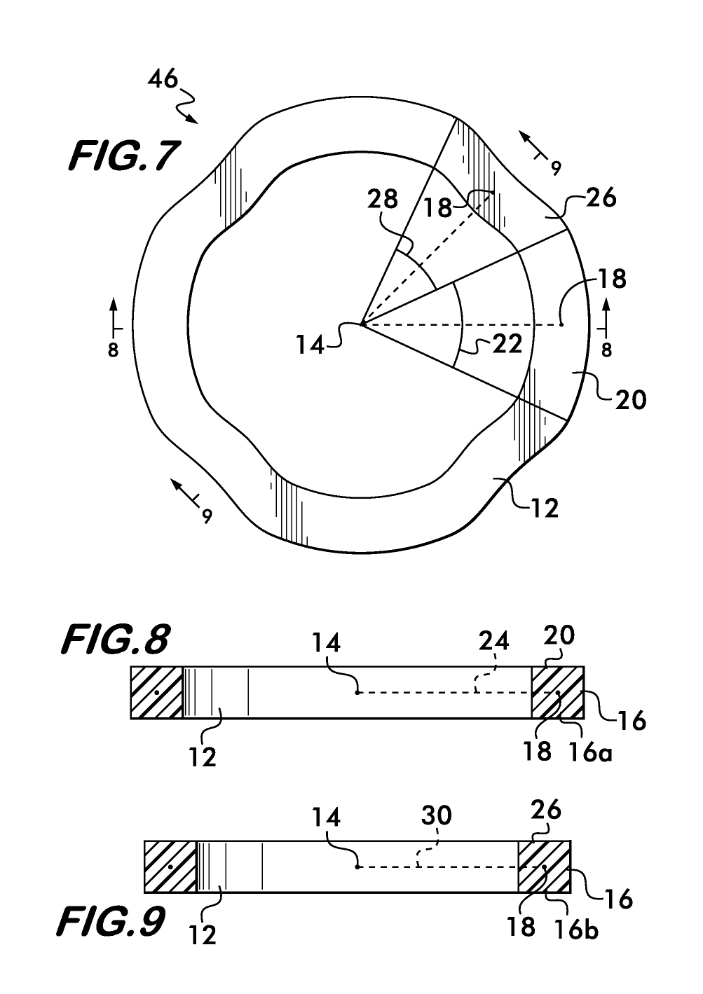

FIGS. 7-9 show another seal embodiment 46 comprising a ring 12 surrounding a point 14 and having a multiplicity of identical cross sections 16, the cross sections being non-round. In the example seal embodiment 46 the cross sections are square in shape, it being understood that other polygons, as well as curved shapes, such as ellipses, ovals and the like are also feasible. Again, ring 12 is divided into a plurality of portions 20 and 26 which subtend respective angles 22 and 28, the portions being distinguishable from each other by the respective distances 24 and 30 of the centroids 18 of the cross sections 16a and 16b from the point 14. In this example the portions 26 curve inwardly toward point 14 similar to the embodiment shown in FIG. 1, but it is understood that the portions could curve outwardly as in the example seal embodiment shown in FIG. 4. Other arrangements of portions 26 are also feasible.

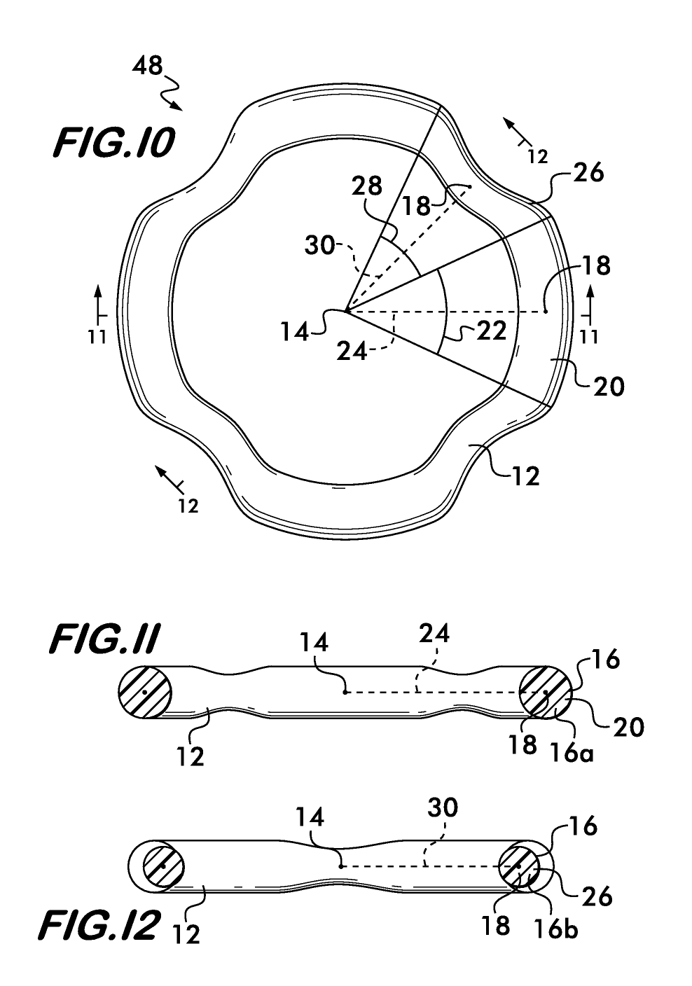

While the example seal embodiments shown in FIGS. 1-9 all have cross sections 16 that are identical to one another in shape and area, FIGS. 10-12 illustrate an example seal embodiment 48 wherein the cross sections 16 all have the same shape at every position along the entire length of the ring 12, but the cross sections 16b of portions 26 have different areas from the areas of cross sections 16a of portions 20. In this example the areas of cross sections 16b in portions 26 are smaller than the areas of cross sections 16a in portions 20, as shown by a comparison of FIGS. 11 and 12. It is also feasible to have areas of cross sections 16b be larger than the areas of cross sections 16a. In this example embodiment 48, the portions 26 curve inwardly toward point 14 similar to the embodiment shown in FIG. 1, but it is understood that the portions could curve outwardly as in the example seal embodiment shown in FIG. 4. Other arrangements of portions 26 are also feasible.

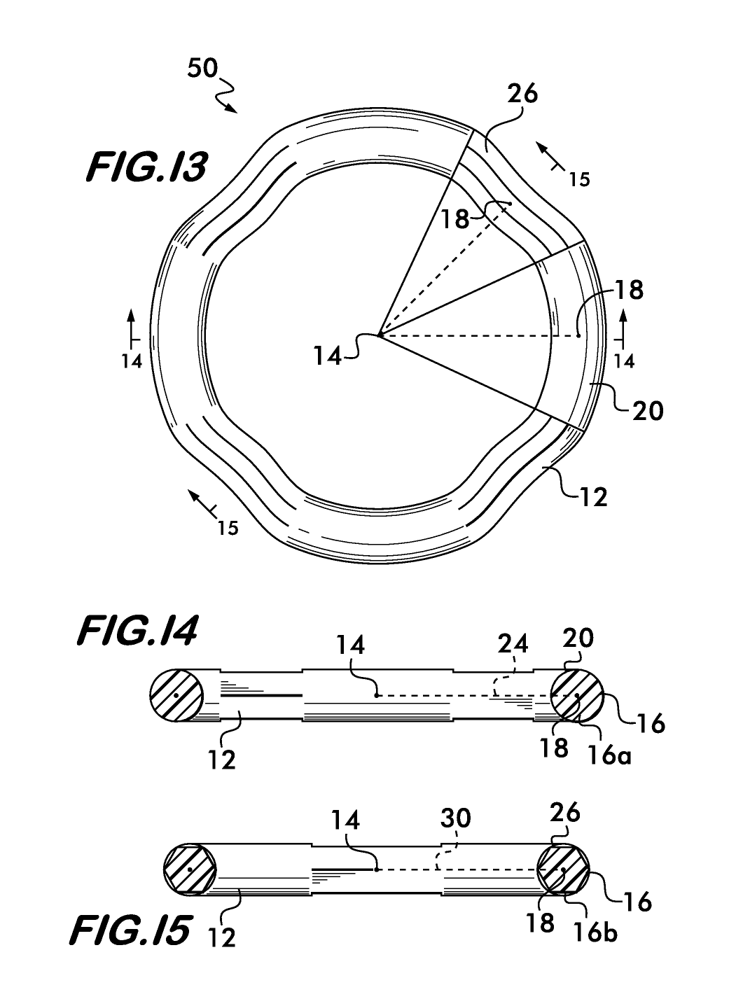

FIGS. 13-15 show yet another embodiment 50 of a seal according to the invention wherein all of the cross sections have identical areas at every position along the entire length of the ring 12, but the cross sections 16a within portions 20 have a different shape from the cross sections 16b within portions 26. In this example seal 50 the cross sections 16a have a round shape (see FIG. 14) whereas the cross sections 16b have a hexagonal shape (see FIG. 15). It is further understood that these shapes are provided by way of example only, and other shapes could be used as well. In this example, the portions 26 curve inwardly toward point 14 similar to the embodiment shown in FIG. 1, but it is understood that the portions could curve outwardly as in the example seal embodiment shown in FIG. 4. Other arrangements of portions 26 are also feasible.

Seals as illustrated herein according to the invention find use to seal crimp-type pipe joints for pipe sizes from about ½ inch to 2 inches. For practical designs the cross sectional diameter for a circular cross section will range from about ⅛ inches to about ¼ inches and the outside diameter of the ring 12 may range from about 1 inch to about 3 inches when measured across opposing portions 20. When measured across portions 26 the outside diameter of ring 12 may range from about 1 inch to about 3 inches for the seal embodiment 10 shown in FIG. 1. Seals according to the invention are formed of flexible materials such as EPDM, PTFE, as well as nitriles such as HNBR (hydrogenated nitrile), which allow them to deform when compressed and conform to the shape of the interfacing surface to be sealed.

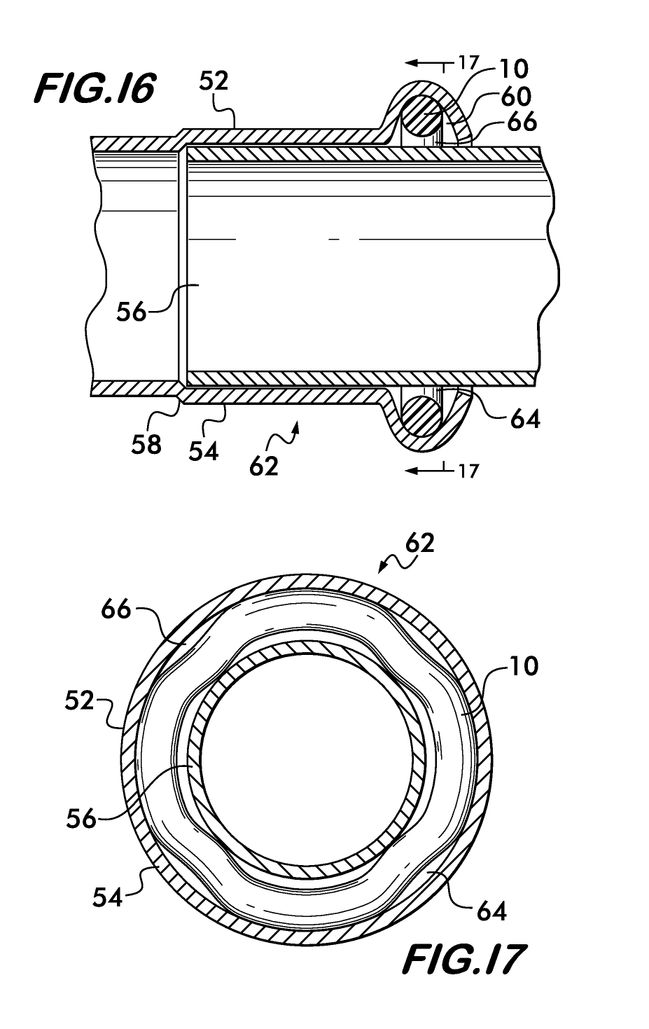

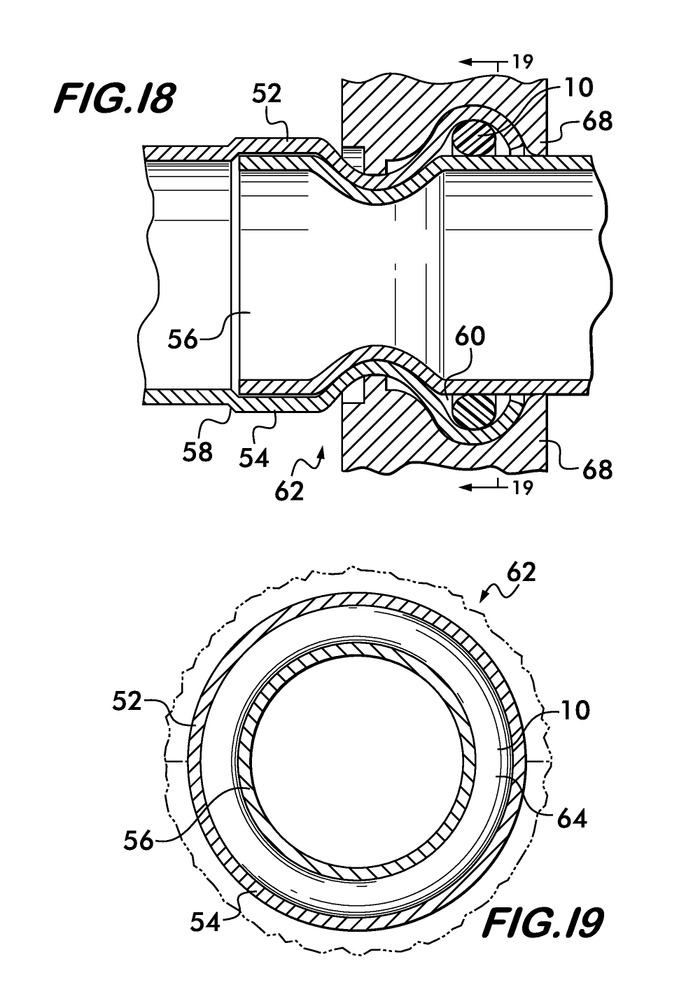

FIGS. 16-19 illustrate the seal 10 according to the invention in use to seal a crimp-type pipe coupling. As shown in FIG. 16, the pipe coupling 52 comprises a socket 54 sized to receive the end of a pipe element 56. A shoulder 58 within the coupling helps define the socket and provides a stop which contacts and limits the extent to which pipe element 56 engages the coupling. An inwardly facing groove 60 is positioned within the socket 54 and receives the seal 10. As best shown in FIGS. 16 and 17, when the pipe element 56 is inserted within the socket 54 to form a joint 62, the seal 10, by virtue of its shape, which does not conform to the annular space 64 between the socket and the pipe element, provides leak paths 66 which prevent the seal from being fluid tight with the pipe element merely inserted into the socket. Thus even under very low fluid pressure, applied as a test of the integrity of the piping network of which the joint 62 is a part, the joint formed using seal 10 will leak and provide an indication that the coupling 52 has not been crimped. However, when, as shown in FIGS. 18 and 19, the coupling 52 is crimped by radial forces applied by a crimping tool 68, the seal 10 is compressed between the pipe element 56 and the coupling 52 and is deformed to occupy the annular space 64 and thereby provide a fluid tight seal even under high internal pressures.

The use of seals according to the invention will enable piping networks to be constructed while significantly reducing the risk of damage from joints blowing apart under service pressure because they have not been crimped, but, have nevertheless satisfied pressure testing.

What is claimed is:

1. A seal, comprising:
a ring surrounding a point, said ring having a multiplicity of cross sections, said cross sections being identical to one another in shape and area at every position along the entire length of said ring, each of said cross sections having a centroid;
a first portion of said ring subtending a first angle measured about said point, wherein said centroid of every said cross section within said first portion is positioned at a first distance from said point;
a second portion of said ring subtending a second angle measured about said point, wherein said centroid of every said cross section within said second portion is positioned at a distance from said point different from said first distance.

2. The seal according to claim 1, further comprising a plurality of said first portions and a plurality of said second portions, each of said second portions being positioned between two of said first portions.

3. The seal according to claim 2, wherein each one of said first angles is greater than each one of said second angles.

4. The seal according to claim 2, wherein each one of said first angles is less than each one of said second angles.

5. The seal according to claim 2, wherein said first angles and said second angles are equal to one another.

6. The seal according to claim 1, further comprising at least four of said first portions and four of said second portions, each of said second portions being positioned between two of said first portions.

7. The seal according to claim 6, wherein each of said first portions subtends an angle from about 40° to about 70°.

8. The seal according to claim 6, wherein each of said second portions subtends an angle from about 20° to about 50°.

9. The seal according to claim 6, wherein said centroids located within said second portions are positioned at respective distances from said point less than said first distance.

10. The seal according to claim 6, wherein said centroids located within said second portions are positioned at respective distances from said point greater than said first distance.

11. The seal according to claim 6, wherein said shape of said cross sections is round.

12. The seal according to claim 6, wherein at least some of said centroids located within said second portion lie on a circle having its center outside of the ring.

13. The seal according to claim 1, wherein said shape of said cross sections is round.

14. The seal according to claim 1, wherein said shape of said cross sections is non-round.

15. The seal according to claim 1, wherein said ring is formed of an elastic material.

16. The seal according to claim 1, wherein said centroids located within said second portion are positioned at respective distances from said point less than said first distance.

17. The seal according to claim 1, wherein said centroids located within said second portion are positioned at respective distances from said point greater than said first distance.

18. The seal according to claim 1, wherein at least some of said centroids located within said second portion lie on a circle having its center outside of the ring.

19. A seal, comprising:
a ring surrounding a point, said ring having a multiplicity of cross sections, said cross sections being identical to one another in shape at every position along the entire length of said ring, each of said cross sections having a centroid;
a first portion of said ring subtending a first angle measured about said point, wherein said centroid of every said cross section within said first portion is positioned at a first distance from said point;
a second portion of said ring subtending a second angle measured about said point, wherein said centroid of every said cross section within said second portion is positioned at a distance from said point different from said first distance.

20. The seal according to claim 19, further comprising a plurality of said first portions and a plurality of said second portions, each of said second portions being positioned between two of said first portions.

21. The seal according to claim 20, wherein each one of said first angles is greater than each one of said second angles.

22. The seal according to claim 20, wherein each one of said first angles is less than each one of said second angles.

23. The seal according to claim 20, wherein said first angles are equal to said second angles.

24. The seal according to claim 19, further comprising at least four of said first portions and four of said second portions, each of said second portions being positioned between two of said first portions.

25. The seal according to claim 24, wherein each of said first portions subtends an angle from about 40° to about 70°.

26. The seal according to claim 24, wherein each of said second portions subtends an angle from about 20° to about 50°.

27. The seal according to claim 19, wherein said shape of said cross sections is round.

28. The seal according to claim 19, wherein said shape of said cross sections is non-round.

29. The seal according to claim 19, wherein said ring is formed of an elastic material.

30. The seal according to claim 19, wherein said centroids located within said second portion are positioned at respective distances from said point less than said first distance.

31. The seal according to claim 19, wherein said centroids located within said second portion are positioned at respective distances from said point greater than said first distance.

32. A seal, comprising:
a ring surrounding a point, said ring having a multiplicity of cross sections, said cross sections being identical to one another in area at every position along the entire length of said ring, each of said cross sections having a centroid;
a first portion of said ring subtending a first angle measured about said point, wherein said centroid of every said cross section within said first portion is positioned at a first distance from said point;
a second portion of said ring subtending a second angle measured about said point, wherein said centroid of every said cross section within said second portion is positioned at a distance from said point different from said first distance.

33. The seal according to claim 32, further comprising a plurality of said first portions and a plurality of said second portions, each of said second portions being positioned between two of said first portions.

34. The seal according to claim 33, wherein each one of said first angles is greater than each one of said second angles.

35. The seal according to claim 33, wherein each one of said first angles is less than each one of said second angles.

36. The seal according to claim 33, wherein said first angles are equal to said second angles.

37. The seal according to claim 32, further comprising at least four of said first portions and four of said second portions, each of said second portions being positioned between two of said first portions.

38. The seal according to claim 37, wherein each of said first portions subtends an angle from about 40° to about 70°.

39. The seal according to claim 37, wherein each of said second portions subtends an angle from about 20° to about 50°.

40. The seal according to claim 32, wherein said ring is formed of an elastic material.

41. The seal according to claim 32, wherein said centroids located within said second portion are positioned at respective distances from said point less than said first distance.

42. The seal according to claim 32, wherein said centroids located within said second portion are positioned at respective distances from said point greater than said first distance.
